(19) United States
(12) Patent Application Publication
(10) Pub. No.: US 2013/0091025 A1
(43) Pub. Date: Apr. 11, 2013

(54) METHODS AND SYSTEMS FOR MEASURING ADVERTISEMENT EFFECTIVENESS

(71) Applicants: Ayman Farahat, San Fracisco, CA (US); Tarun Bhatia, Simi Valley, CA (US)

(72) Inventors: Ayman Farahat, San Fracisco, CA (US); Tarun Bhatia, Simi Valley, CA (US)

(73) Assignee: Yahoo! Inc., Sunnyvale, CA (US)

(21) Appl. No.: 13/267,518

(22) Filed: Oct. 6, 2011

(51) Int. Cl. G06Q 30/02

(52) U.S. Cl. 705/14.73

(57) ABSTRACT

Methods and systems are disclosed which allow determining the effect of advertising on users' online activity. A tracking pixel may be placed on a merchant's website (e.g., on a welcome page) which allows an advertisement provider to receive identification information for each user who visits the webpage, and allows the advertisement provider to provide or receive cookie information to a user's browser application. The advertisement provider may create a list of users comprising at least part of the cookie information and the corresponding identification information for each user. The advertisement provider may select at least two groups of users from the list of users, wherein a first group of users is served advertisements relating to the merchant, and a second group of users, different from the first group, is not served advertisements relating to the merchant.

### BACKGROUND

Measuring the causal impact of advertising has been a significant concern in digital advertising. Traditionally, advertisement effectiveness has been determined by matching merchants' users as identified by one or more of e.g., name, address and email, to an advertisement provider's user registration data. However, due to the private nature of this information, the matching is entrusted to a trusted third party. This increases the time and cost of determining the effectiveness of advertising.

There is a need for techniques for improving the measurement of advertising effectiveness.

### SUMMARY

Some embodiments of the invention provide systems and methods which allow determining the effect of advertisements on users' online activity. Upon each user visiting a merchant's website, an advertisement provider may obtain identification information for each user, and the advertisement provider may transmit cookie information (or other information, such as other identifier information or identification facilitation information) to each user's browser application. In accordance with an exemplary embodiment, the identification information may be generated and provided by the merchant computers. The identification information may include, for example, a unique identifier for each user in order to preserve user privacy. In accordance with an exemplary embodiment, the identification information may be received by the advertisement provider, and the cookie information may be received (if the user has previously visited the website) or transmitted (if the user has not previously visited the website) by the advertisement provider upon a user visiting a predetermined webpage on the website. The predetermined webpage may be, for example, a welcome page after the user logs-in to the website. The identification information and the cookie information may be received or transmitted automatically upon the user visiting the predetermined page (e.g., the welcome page) using for example, a tracking pixel.

As will be understood by one or ordinary skill in the art, a tracking pixel, which is identified using an image tag representing a 1×1 image on a webpage, allows for tracking a user's online activity.

A list of users comprising at least part of the cookie information and the corresponding identification information for each user may be created. In accordance with an exemplary embodiment, the list identifies each user using the cookie information and the corresponding identification information, thereby preserving user privacy. At least two groups of users may be selected from the list of users, wherein a first group of users is served advertisements relating to the merchant, and a second group of users, different from the first group, is not served advertisements relating to the merchant. In accordance with an exemplary embodiment, the first group of users may be treated as a test group and the second group of users may be treated as a control group. The second group of users i.e., the control group, are users who ordinarily would have been served advertisements related to the merchant, but now will not be served with advertisements relating to the merchant.

In some embodiments, the advertisement provider may provide this information (i.e., the information indicating which users were served advertisements related to the merchant and which users were not served advertisements related to the merchant), wherein the users are identified using e.g. the unique identifier, to the merchant. Based at least in part on this information, the merchant may determine the effect of the advertisements on one or more predetermined metrics. For example, the merchant may determine whether the group of users who were served with advertisements related to the merchant had a higher conversion rate (e.g., made a purchase) or if they conducted additional product searches on the merchant's website than the group of users who were not served with advertisements related to the merchant. It should be noted that conversion rate and search history are exemplary metrics and any other suitable metric may be used.

In some embodiments, the merchant may provide the metric related information, such as the conversion rates, search history, etc. for each user, wherein the users are identified using, for example, the unique identifier, to the advertisement provider. The advertisement provider may then determine the effect of the advertisements on the one or more predetermined metrics based at least in part on the information indicating which users were served advertisements related to the merchant and which users were not served advertisements related to the merchant and the information received from the merchant.

In alternate embodiments, the advertisement provider may provide the information indicating which users were served advertisements related to the merchant and which users were not served advertisements related to the merchant to a trusted third party, and the merchant may provide the metric related information to the third party, wherein both sets of information (i.e., information from the advertisement provider and information from the merchant) may identify the users using the unique identifier to preserve user privacy. The third party may determine the effect of the advertisements on predetermined metrics based at least on part on the information received from the merchant and the advertisement provider.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a flow diagram illustrating a method according to one embodiment of the invention; and

FIG. 5 is a block diagram illustrating one embodiment of the invention.

### DETAILED DESCRIPTION

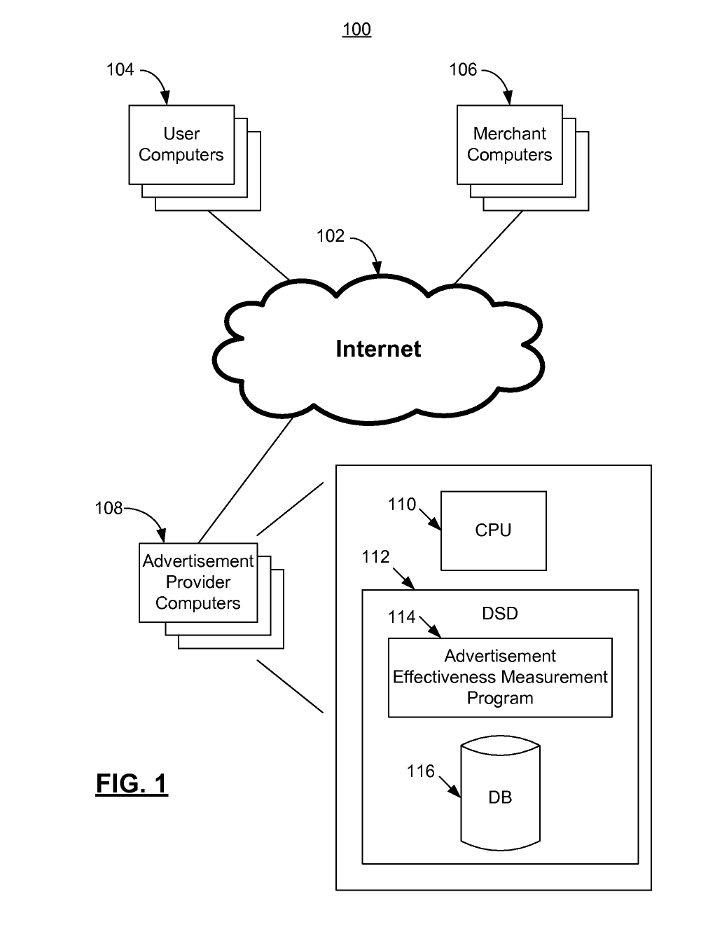

FIG. 1 is a distributed computer system 100 according to one embodiment of the invention. The system 100 includes user computers 104, merchant computers 106 and advertisement provider computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers 104 may be or include desktop or laptop PCs, as well as, wireless, mobile, or handheld devices such as cell phones, PDAs, tablets, etc.

Each of the one or more computers 104, 106 and 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the advertiser computers 108 may be implemented as one or more servers and include one or more CPUs 110 and a data storage device 112. The data storage device 112 includes a database 116 and an Advertisement Effectiveness Measurement Program 114. As will be understood by one of ordinary skill in the art, merchant computers 106 may be implemented as one or more servers similar to advertisement provider computers 108.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

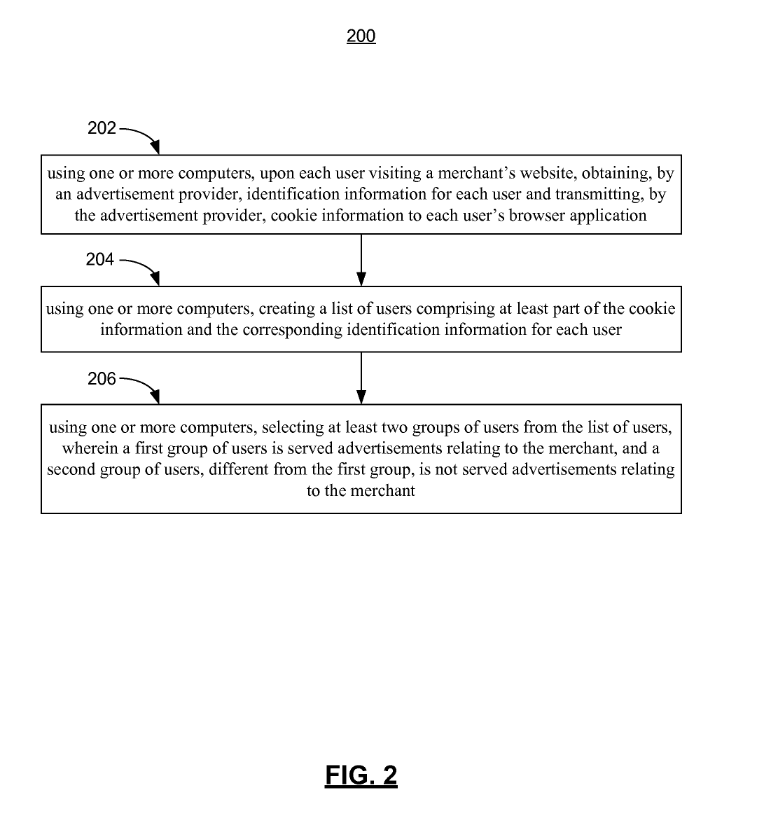

FIG. 2 is a flow diagram illustrating a method 200 according to one embodiment of the invention. At step 202, using one or more computers, upon each user visiting a merchant's website, an advertisement provider may obtain identification information for each user, and the advertisement provider may transmit cookie information to each user's browser application. The cookie information may comprise one or more browser cookies, and may be anonymous. Alternatively, in some embodiments, if a user has previously visited the site, the cookie information may be transmitted by the user's browser application to one or more of the advertisement provider's server computers. The cookie information may have been issued by one or more servers and stored on a storage device in the user's computer device when the user previously visited the website. In accordance with an exemplary embodiment, the identification information may be generated and provided by the merchant computers. The identification information may include, for example, a unique identifier for each user in order to preserve user privacy. In accordance with an exemplary embodiment, the identification information may be received by the advertisement provider, and the cookie information may be received (if the user has previously visited the website) or transmitted (if the user has not previously visited the website) by the advertisement provider upon a user visiting a predetermined webpage on the website. The predetermined webpage may be, for example, a welcome page after the user logs-in to the website. The identification information and the cookie information may be received or transmitted automatically upon the user visiting the predetermined page (e.g., the welcome page) using for example, a tracking pixel.

As will be understood by one or ordinary skill in the art, a tracking pixel, which is identified using an image tag representing a 1×1 image on a webpage, allows for tracking a user's online activity. In accordance with an exemplary embodiment, when a user visits a webpage including a tracking pixel, the identification information may be automatically received by the advertisement provider and the cookie information may be automatically received or transmitted by the advertisement provider.

At step 204, a list of users comprising at least part of the cookie information and the corresponding identification information for each user may be created. In accordance with an exemplary embodiment, the list identifies each user using the cookie information and the corresponding identification information, thereby preserving user privacy.

At step 206, at least two groups of users may be selected from the list of users, wherein a first group of users is served advertisements relating to the merchant, and a second group of users, different from the first group, is not served advertisements relating to the merchant. In accordance with an exemplary embodiment, the first group of users may be treated as a test group and the second group of users may be treated as a control group. The second group of users i.e., the control group, are users who ordinarily would have been served advertisements related to the merchant, but now will not be served with advertisements relating to the merchant.

In some embodiments, the advertisement provider may provide this information (i.e., the information indicating which users were served advertisements related to the merchant and which users were not served advertisements related to the merchant), wherein the users are identified using e.g. the unique identifier, to the merchant. Based at least in part on this information, the merchant may determine the effect of the advertisements on one or more predetermined metrics. For example, the merchant may determine whether the group of users who were served with advertisements related to the merchant had a higher conversion rate (e.g., made a purchase) or if they conducted additional product searches on the merchant's website than the group of users who were not served with advertisements related to the merchant. It should be noted that conversion rate and search history are exemplary metrics and any other suitable metric may be used.

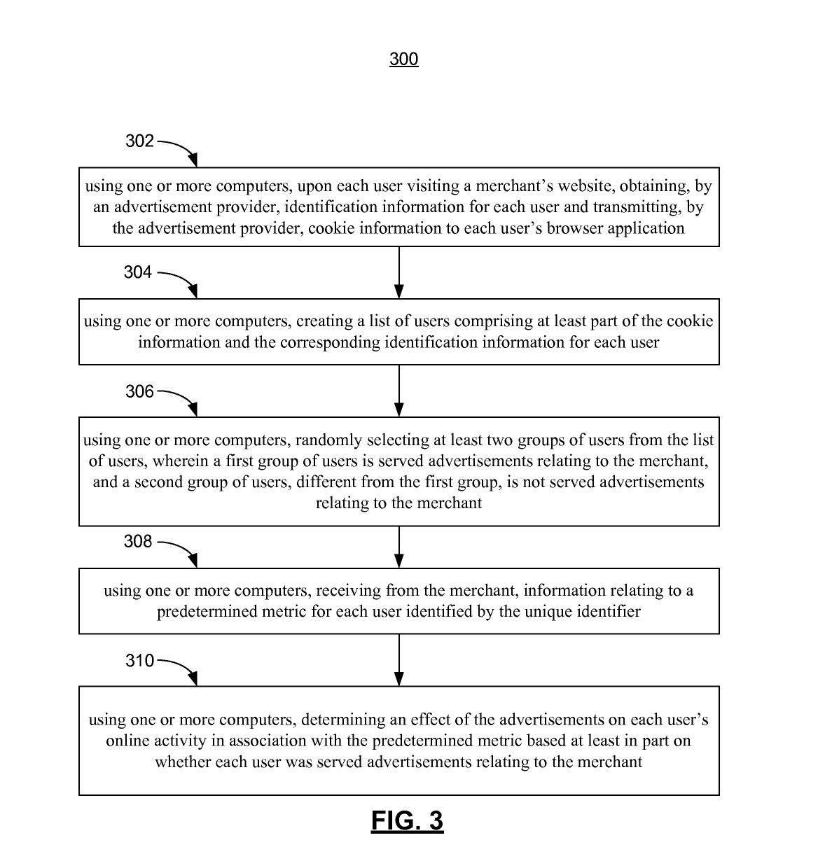

FIG. 3 is a flow diagram illustrating a method 300 according to one embodiment of the invention. At step 302, using one or more computers, upon each user visiting a merchant's website, an advertisement provider may obtain identification information for each user, and the advertisement provider may transmit cookie information to each user's browser application. The cookie information may comprise one or more browser cookies, and may be anonymous. Alternatively, in some embodiments, if a user has previously visited the site, the cookie information may be transmitted by the user's browser application to one or more of the advertisement provider's server computers. The cookie information may have been issued by one or more servers and stored on a storage device in the user's computer device when the user previously visited the website. In accordance with an exemplary embodiment, the identification information may be generated and provided by the merchant computers. The identification information may include, for example, a unique identifier for each user in order to preserve user privacy. In accordance with an exemplary embodiment, the identification information may be received by the advertisement provider, and the cookie information may be received (if the user has previously visited the website) or transmitted (if the user has not previously visited the website) by the advertisement provider upon a user visiting a predetermined webpage on the website. The predetermined webpage may be, for example, a welcome page after the user logs-in to the website. The identification information and the cookie information may be received or transmitted automatically upon the user visiting the predetermined page (e.g., the welcome page) using for example, a tracking pixel.

At step 304, a list of users comprising at least part of the cookie information and the corresponding identification information for each user may be created. In accordance with an exemplary embodiment, the list identifies each user using the cookie information and the corresponding identification information, thereby preserving user privacy.

At step 306, at least two groups of users may be randomly selected from the list of users, wherein a first group of users is served advertisements relating to the merchant, and a second group of users, different from the first group, is not served advertisements relating to the merchant. In accordance with an exemplary embodiment, the first group of users may be treated as a test group and the second group of users may be treated as a control group. The second group of users i.e., the control group, are users who ordinarily would have been served advertisements related to the merchant, but now will not be served with advertisements relating to the merchant.

At step 308, using one or more computers, the advertisement provider may receive from the merchant information relating to a predetermined metric for each user identified by the unique identifier. The metric information may include information relating to for example, conversion rates (e.g., whether a user made a purchase on the merchant's website), search history (whether the user conduct a product search on the merchant's website), etc. for each user, wherein the users are identified using, for example, the unique identifier. At step 310, using one or more computers, the advertisement provider may determine an effect of the advertisements on each user's online activity in association with the predetermined metric based at least in part on whether each user was served advertisements relating to the merchant. For example, the advertisement provider may determine whether the group of users who were served with advertisements related to the merchant had a higher conversion rate (e.g., made a purchase) or if they conducted additional product searches on the merchant's website than the group of users who were not served with advertisements related to the merchant. It should be noted that conversion rate and search history are exemplary metrics and any other suitable metric may be used.

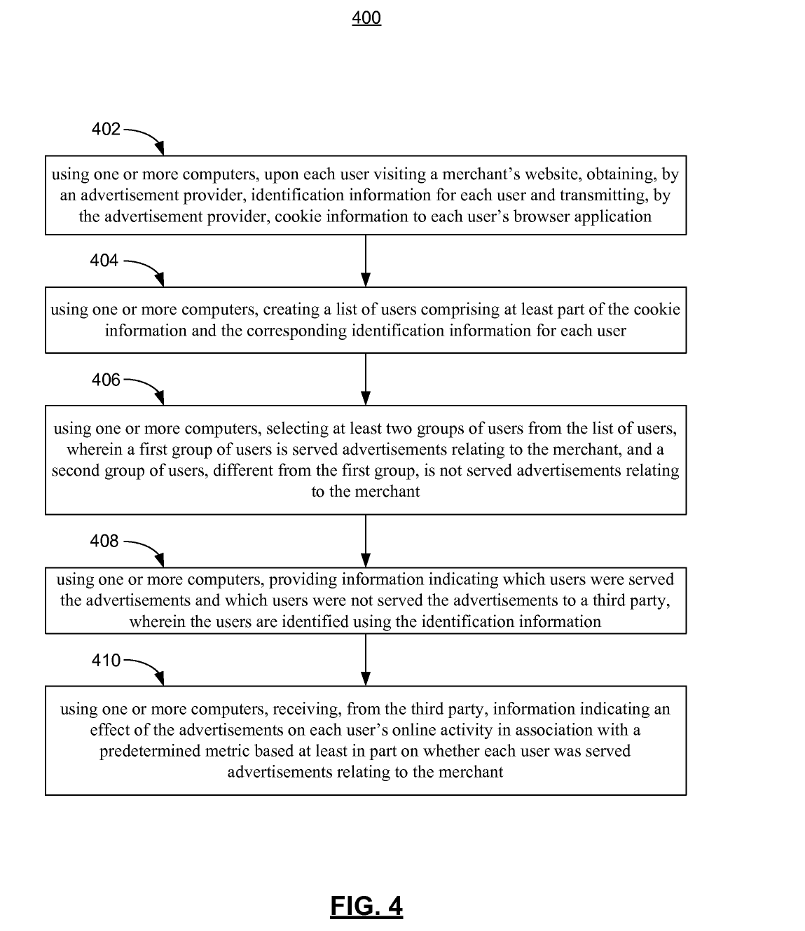

FIG. 4 is a flow diagram illustrating a method 400 according to one embodiment of the invention. At step 402, using one or more computers, upon each user visiting a merchant's website, an advertisement provider may obtain identification information for each user, and the advertisement provider may transmit cookie information to each user's browser application. The cookie information may comprise one or more browser cookies, and may be anonymous. Alternatively, in some embodiments, if a user has previously visited the site, the cookie information may be transmitted by the user's browser application to one or more of the advertisement provider's server computers. The cookie information may have been issued by one or more servers and stored on a storage device in the user's computer device when the user previously visited the website. In accordance with an exemplary embodiment, the identification information may be generated and provided by the merchant computers. The identification information may include, for example, a unique identifier for each user in order to preserve user privacy. In accordance with an exemplary embodiment, the identification information may be received by the advertisement provider, and the cookie information may be received (if the user has previously visited the website) or transmitted (if the user has not previously visited the website) by the advertisement provider upon a user visiting a predetermined webpage on the website. The predetermined webpage may be, for example, a welcome page after the user logs-in to the website. The identification information and the cookie information may be received or transmitted automatically upon the user visiting the predetermined page (e.g., the welcome page) using for example, a tracking pixel.

At step 404, a list of users comprising at least part of the cookie information and the corresponding identification information for each user may be created. In accordance with an exemplary embodiment, the list identifies each user using the cookie information and the corresponding identification information, thereby preserving user privacy.

At step 406, at least two groups of users may be selected from the list of users, wherein a first group of users is served advertisements relating to the merchant, and a second group of users, different from the first group, is not served advertisements relating to the merchant. In accordance with an exemplary embodiment, the first group of users may be treated as a test group and the second group of users may be treated as a control group. The second group of users i.e., the control group, are users who ordinarily would have been served advertisements related to the merchant, but now will not be served with advertisements relating to the merchant.

At step 408, using one or more computers, the advertisement provider may provide information indicating which users were served the advertisements and which users were not served the advertisements to a third party. The merchant may also provide the metric related information to the third party. Both sets of information (i.e., information from the advertisement provider and information from the merchant) may identify the users using the unique identifier to preserve user privacy. In alternate embodiments, the metric related information may also be provided by the advertisement provider to the third party. The third party may then determine the effect of the advertisements on the predetermined metrics based at least on part on the information received from the merchant and the advertisement provider. At step 410, using one or more computers, the advertisement provider may receive from the third party, information indicating an effect of the advertisements on each user's online activity in association with a predetermined metric based at least in part on whether each user was served advertisements relating to the merchant. For example, the third party may determine whether the group of users who were served with advertisements related to the merchant had a higher conversion rate (e.g., made a purchase) or if they conducted additional product searches on the merchant's website than the group of users who were not served with advertisements related to the merchant.

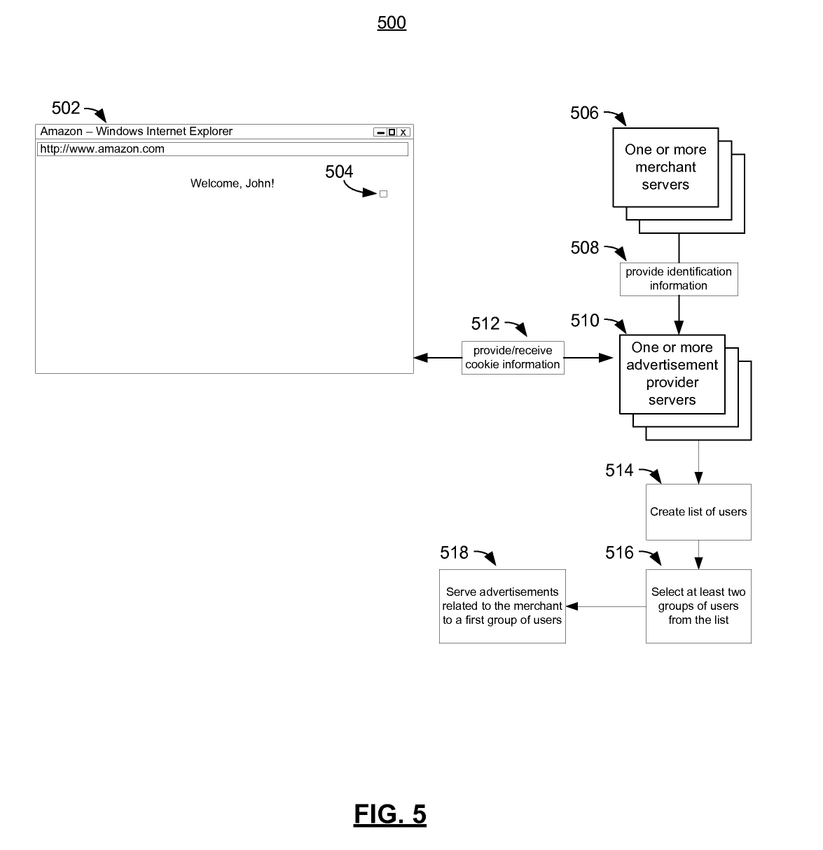

FIG. 5 is a block diagram 500 illustrating one embodiment of the invention. An exemplary welcome page 502 is displayed in a browser application after a user logs into a site such as, for example, www.amazon.com. Webpage 502 includes a tracking pixel 504. As will be understood by one or ordinary skill in the art, the tracking pixel is usually a 1×1 transparent image not usually visible to a user. It is shown in FIG. 5 for illustration purposes. When the welcome page, and therefore the tracking pixel, is displayed, one or more merchant servers (e.g., Amazon servers) provide identification information of the user, as depicted in block 508, to one or more advertisement provider servers 510. The identification information may include a unique identifier generated by the merchant. One or more advertisement provider servers 510 may also transmit or receive cookie information to or from the user's browser application. The cookie information may be an anonymous browser cookie. As depicted in block 514, a list of users comprising at least part of the cookie information and the corresponding identification information for each user may be created. In accordance with an exemplary embodiment, the list identifies each user using the cookie information and the corresponding identification information, thereby preserving user privacy.

As depicted in block 516, at least two groups of users may be selected from the list of users. In accordance with an exemplary embodiment, the first group of users may be treated as a test group and the second group of users may be treated as a control group. In some embodiments, the users may be selected randomly. As depicted in block 518, a first group of users is served advertisements relating to the merchant, and a second group of users, different from the first group, is not served advertisements relating to the merchant. The second group of users i.e., the control group, are users who ordinarily would have been served advertisements related to the merchant, but now will not be served with advertisements relating to the merchant.

An exemplary scenario will now be described in accordance with the embodiment described above in connection with FIG. 5. Once the advertisement provider has divided the users into at least two groups (one group will be served advertisements related to the merchant, and one group will not be served advertisements related to the merchant), the advertisement provider may keep track of which users were served advertisements and which users were not served advertisements for a predetermined period of time using the unique identifier and/or the cookie information. In one embodiment, the advertisement provider may then provide this information indicating which users were served advertisements and which users were not served advertisements to Amazon. Amazon may determine the effect of the advertisements on one or more predetermined metrics, such as conversion rates, search history, etc. based at least in part on the information received from the advertisement provider. In an alternate embodiment, Amazon may provide the predetermined metric information to the advertisement provider, and the advertisement provider may determine the effect of the advertisements on one or more metrics based at least in part on the information indicating which users were served advertisements and which users were not served advertisements. In another embodiment, Amazon may provide the metric information to a third party and the advertisement provider may also provide the information indicating which users were served advertisements and which users were not served advertisements to the third party. The third party may then determine the effect of the advertisements on one or more metrics based at least in part on the metric information and the information indicating which users were served advertisements and which users were not served advertisements.

It should be noted that in some embodiments, a tracking pixel need not be placed on the merchant's website. For example, if a user is accessing the website using a mobile browser (e.g., using a smart phone), the user's mobile identification number (MIN) and the user's IP address may be used to identify and track the user's online activity without compromising user privacy. As will be understood by one of ordinary skill in the art, MIN refers to the 10-digit unique number that a wireless carrier uses to identify a mobile phone.

While the invention is described with reference to the above drawings, the drawings are intended to be illustrative, and the invention contemplates other embodiments within the spirit of the invention.

1. A method comprising:
using one or more computers, upon each user visiting a first entity's website, obtaining, by a second entity, identification information for each user and transmitting, by the second entity, identifier information to each user's browser application;
wherein the identification information comprises a unique identifier assigned by the first entity to each user;
using one or more computers, creating a list of users comprising at least part of the identifier information and the corresponding identification information for each user; and
using one or more computers, selecting at least two groups of users from the list of users, wherein a first group of users is served advertisements relating to the first entity, and a second group of users, different from the first group, is not served advertisements relating to the first entity.

2. The method of claim 1, wherein the first entity is a merchant, and wherein the second entity is an advertisement provider, and wherein the identifier information comprises cookie information, and further comprising:
using one or more computers, transmitting to the merchant, information indicating which users were served advertisements relating to the merchant and which users were not served advertisements relating to the merchant.

3. The method of claim 2, further comprising:
using one or more computers, receiving from the merchant, information relating to a predetermined metric for each user identified by the unique identifier.

4. The method of claim 2, further comprising:
using one or more computers, transmitting to a trusted third party information indicating which users were served advertisements relating to the merchant and which users were not served advertisements relating to the merchant.

5. The method of claim 3, wherein the predetermined metric is a conversion rate for each user.

6. The method of claim 3, wherein the predetermined metric is a search history on the merchant's website for each user.

7. The method of claim 1, wherein selecting the at least two groups of users comprises randomly selecting the at least two groups of users.

8. The method of claim 3, further comprising:
using one or more computers, determining an effect of the advertisements on each user's online activity, offline activity, or online and offline activity, in association with the predetermined metric based at least in part on whether each user was served advertisements relating to the merchant.

9. The method of claim 2, wherein the merchant's website comprises a tracking pixel.

10. A system comprising:
one or more server computers coupled to a network; and
one or more databases coupled to the one or more server computers;
wherein the one or more server computers are for:
upon each user visiting a merchant's website, obtaining, by an advertisement provider, identification information for each user and transmitting, by the advertisement provider, cookie information to each user's browser application;
wherein the identification information comprises a unique identifier assigned by the merchant to each user;
creating a list of users comprising at least part of the cookie information and the corresponding identification information for each user; and
selecting at least two groups of users from the list of users, wherein a first group of users is served advertisements relating to the merchant, and a second group of users, different from the first group, is not served advertisements relating to the merchant.

11. The system of claim 10, wherein the one or more server computers are for:
transmitting to the merchant, information indicating which users were served advertisements relating to the merchant and which users were not served advertisements relating to the merchant.

12. The system of claim 10, wherein the one or more server computers are for:
receiving from the merchant, information relating to a predetermined metric for each user identified by the unique identifier.

13. The system of claim 10, wherein the one or more server computers are for:
transmitting to a trusted third party information indicating which users were served advertisements relating to the merchant and which users were not served advertisements relating to the merchant.

14. The system of claim 12, wherein the one or more server computers are for:
determining an effect of the advertisements on each user's online activity in association with the predetermined metric based at least in part on whether each user was served advertisements relating to the merchant.

15. The system of claim 12, wherein the predetermined metric is a conversion rate for each user.

16. The system of claim 12, wherein the predetermined metric is a search history on the merchant's website for each user.

17. The system of claim 10, wherein selecting the at least two groups of users comprises randomly selecting the at least two groups of users.

18. The system of claim 10, wherein the cookie information comprises a browser cookie.

19. The system of claim 10, wherein the merchant's website comprises a tracking pixel.

20. A computer readable medium or media containing instructions for executing a method comprising:
using one or more computers, upon each user visiting a merchant's website, obtaining, by an advertisement provider, identification information for each user and transmitting, by the advertisement provider, cookie information to each user's browser application;
wherein the identification information comprises a unique identifier assigned by the merchant to each user;
using one or more computers, creating a list of users comprising at least part of the cookie information and the corresponding identification information for each user;
using one or more computers, randomly selecting at least two groups of users from the list of users, wherein a first group of users is served advertisements relating to the merchant, and a second group of users, different from the first group, is not served advertisements relating to the merchant;
using one or more computers, receiving from the merchant, information relating to a predetermined metric for each user identified by the unique identifier; and
using one or more computers, determining an effect of the advertisements on each user's online activity in association with the predetermined metric based at least in part on whether each user was served advertisements relating to the merchant.
